(19) United States
(12) Patent Application Publication
(10) Pub. No.: US 2026/0362447 A1
(43) Pub. Date: Nov. 12, 2026

(54) METHOD AND DEVICE FOR TRANSMISSION/RECEPTION OF PTRS IN WIRELESS COMMUNICATION SYSTEM

(71) Applicant: LG ELECTRONICS INC., Seoul (KR)

(72) Inventors: Chanho JEONG, Seoul (KR); Hyungtae KIM, Seoul (KR); Jiwon KANG, Seoul (KR)

(73) Assignee: LG ELECTRONICS INC., Seoul (KR)

(21) Appl. No.: 19/125,986

(22) PCT Filed: Nov. 1, 2023
(86) PCT No.: PCT/KR2023/017301

§ 371 Date: Apr. 30, 2025

(30) Foreign Application Priority Data
Nov. 2, 2022 (KR) 10-2022-0144725

(51) Int. Cl. H04W 72/231; H04L 1/00; H04L 5/00; H04W 72/0453

(52) U.S. Cl. CPC H04W 72/231; H04L 1/0003; H04L 5/0044; H04L 5/0051; H04W 72/0453

(57) ABSTRACT

A method performed by a user equipment according to an embodiment of the present disclosure includes receiving uplink configuration information related to a PTRS, receiving DCI for scheduling a PUSCH, transmitting the PTRS based on a time density and a frequency density, and transmitting the PUSCH.

### TECHNICAL FIELD

The present disclosure relates to a method and device for transmitting and receiving PTRS in a wireless communication system.

### BACKGROUND

Mobile communication systems have been developed to provide a voice service while ensuring the activity of a user. However, in the mobile communication system, not only a voice, but also a data service is extended. At present, there is a shortage of resources due to an explosive increase in traffic, and users demand a higher speed service. As a result, a more advanced mobile communication system is required.

Requirements for a next-generation mobile communication system should be able to support the acceptance of explosive data traffic, a dramatic increase in the per-user data rate, the acceptance of a significant increase in the number of connected devices, very low end-to-end latency, and high-energy efficiency. To this end, various technologies are researched, which include dual connectivity, massive multiple input multiple output (MIMO), in-band full duplex, non-orthogonal multiple access (NOMA), super wideband support, device networking, and the like.

Up to two existing PTRS ports are supported. A time/frequency density (Lptrs/Kptrs) for resource mapping of PTRS may be determined based on the comparison between a time/frequency density threshold (ptrs-mcs/Nrb) and the number of Imcs/RBs. In Rel-18, up to eight UL Tx ports are supported, and up to four PTRS ports may be configured/supported.

### DISCLOSURE

### Technical Problem

As described above, in Rel-18, the maximum number of PTRS ports may be set to 4. In this case, PTRS overhead may be doubled compared to the existing operation.

An object of the present disclosure is to provide a method of configuring/determining a time/frequency density for preventing an excessive increase in PTRS overhead.

The technical objects to be achieved by the present disclosure are not limited to those that have been described hereinabove merely by way of example, and other technical objects that are not mentioned can be clearly understood from the following descriptions by those skilled in the art, to which the present disclosure pertains.

### Technical Solution

A method performed by a user equipment in a wireless communication system according to an embodiment of the present disclosure comprises receiving uplink configuration information related to a phase tracking reference signal (PTRS), receiving downlink control information (DCI) for scheduling a physical uplink shared channel (PUSCH), transmitting the PTRS based on a time density and a frequency density, and transmitting the PUSCH.

The DCI includes i) a modulation and coding scheme (MCS) field and ii) a frequency domain resource assignment field.

The time density is determined as one of time density values based on a comparison between an MCS index indicated based on the MCS field and at least one time density threshold.

The frequency density is determined as one of frequency density values based on a comparison between a number of resource blocks (RBs) based on the frequency domain resource assignment field and at least one frequency density threshold.

At least one of the at least one time density threshold, the at least one frequency density threshold, the time density values and/or the frequency density values is based on a maximum number of PTRS ports related to the PTRS.

Based on the maximum number of the PTRS ports being 1 or 2, the time density may be determined as one of first time density values.

Based on the maximum number of the PTRS ports being 3 or 4, the time density may be determined as one of the first time density values and/or second time density values.

The time density for PTRS port 0 and PTRS port 1 among four PTRS ports may be determined as one of the first time density values. The time density for PTRS port 2 and PTRS port 3 among the four PTRS ports may be determined as one of the second time density values.

The PTRS port 0 and the PTRS port 1 may be related to even-numbered RBs or odd-numbered RBs. The PTRS port 2 and the PTRS port 3 may be related to the odd-numbered RBs or the even-numbered RBs.

The at least one time density threshold includes four time density thresholds. For each of three MCS index ranges based on the four time density thresholds, three first time density values and three second time density values may be defined.

For the same MCS index range, the second time density value may be greater than the first time density value.

The at least one time density threshold may include i) first time density thresholds related to the maximum number of the PTRS ports of 1 or 2 and/or ii) second time density thresholds related to the maximum number of the PTRS ports of 3 or 4.

Based on the maximum number of the PTRS ports being 1 or 2, the frequency density may be determined as one of first frequency density values.

Based on the maximum number of the PTRS ports being 3 or 4, the frequency density may be determined as one of the first frequency density values and/or second frequency density values.

The frequency density for PTRS port 0 and PTRS port 1 among four PTRS ports may be determined as one of the first frequency density values. The frequency density for PTRS port 2 and PTRS port 3 among the four PTRS ports may be determined as one of the second frequency density values.

The PTRS port 0 and the PTRS port 1 may be related to even-numbered RBs or odd-numbered RBs. The PTRS port 2 and the PTRS port 3 may be related to the odd-numbered RBs or the even-numbered RBs.

The at least one frequency density threshold may include two frequency density thresholds. For each of two RB number ranges based on the two frequency density thresholds, two first frequency density values and two second frequency density values may be defined.

For the same RB number range, the second frequency density value may be greater than the first frequency density value.

The at least one frequency density threshold may include i) first frequency density thresholds related to the maximum number of the PTRS ports of 1 or 2 and/or ii) second frequency density thresholds related to the maximum number of the PTRS ports of 3 or 4.

A number of layers related to the PUSCH may be greater than 4.

A user equipment operating in a wireless communication system according to another embodiment of the present disclosure comprises one or more transceivers, one or more processors, and one or more memories connected to the one or more processors and storing instructions. The instructions configure the one or more processors to perform all steps of any one of methods performed by the user equipment based on being executed by the one or more processors.

A device according to another embodiment of the present disclosure comprises one or more memories and one or more processors operably connected to the one or more memories. The one or more memories store instructions that configure the one or more processors to perform all steps of any one of methods performed by the user equipment based on being executed by the one or more processors.

One or more non-transitory computer readable mediums according to another embodiment of the present disclosure stores instructions. The instructions executable by one or more processors configure the one or more processors to perform all steps of any one of methods performed by the user equipment.

A method performed by a base station in a wireless communication system according to another embodiment of the present disclosure comprises transmitting uplink configuration information related to a phase tracking reference signal (PTRS), transmitting downlink control information (DCI) for scheduling a physical uplink shared channel (PUSCH), receiving the PTRS based on a time density and a frequency density, and receiving the PUSCH.

The DCI includes i) a modulation and coding scheme (MCS) field and ii) a frequency domain resource assignment field.

The time density is determined as one of time density values based on a comparison between an MCS index indicated based on the MCS field and at least one time density threshold.

The frequency density is determined as one of frequency density values based on a comparison between a number of resource blocks (RBs) based on the frequency domain resource assignment field and at least one frequency density threshold.

At least one of the at least one time density threshold, the at least one frequency density threshold, the time density values and/or the frequency density values is based on a maximum number of PTRS ports related to the PTRS.

A base station operating in a wireless communication system according to another embodiment of the present disclosure comprises one or more transceivers, one or more processors, and one or more memories connected to the one or more processors and storing instructions.

The instructions configure the one or more processors to perform all steps of any one of methods performed by the base station based on being executed by the one or more processors.

### Advantageous Effects

According to embodiments of the present disclosure, RS overhead can be minimized as a maximum number of PTRS ports increases. In addition, various PTRS time/frequency densities determined per the maximum number of PTRS ports can be used. Therefore, the flexibility of PTRS resource mapping can be improved while maintaining the RS overhead the same as before.

Effects which may be obtained from the present disclosure are not limited by the above effects, and other effects that have not been mentioned may be clearly understood from the following description by those skilled in the art to which the present disclosure pertains.

### BRIEF DESCRIPTION OF THE DRAWINGS

FIG. 1 is a flowchart illustrating an example of a DL DMRS procedure.

FIG. 2 is a flowchart illustrating an example of a DL PTRS procedure.

FIG. 3 illustrates an example of an uplink transmission/reception operation.

FIG. 4 is a flowchart illustrating a method performed by a user equipment according to an embodiment of the present disclosure.

FIG. 5 is a flowchart illustrating a method performed by a base station according to another embodiment of the present disclosure.

FIG. 6 illustrates configurations of a first device and a second device according to an embodiment of the present disclosure.

### DETAILED DESCRIPTION

Reference will now be made in detail to embodiments of the present disclosure, examples of which are illustrated in the accompanying drawings. A detailed description to be disclosed below together with the accompanying drawing is to describe exemplary embodiments of the present disclosure and not to describe a unique embodiment for carrying out the present disclosure. The detailed description below includes details to provide a complete understanding of the present disclosure. However, those skilled in the art know that the present disclosure may be carried out without the details.

In some cases, in order to prevent a concept of the present disclosure from being ambiguous, known structures and devices may be omitted or illustrated in a block diagram format based on core functions of each structure and device.

Hereinafter, downlink (DL) means communication from the base station to the terminal and uplink (UL) means communication from the terminal to the base station. In downlink, a transmitter may be part of the base station, and a receiver may be part of the terminal. In uplink, the transmitter may be part of the terminal and the receiver may be part of the base station. The base station may be expressed as a first communication device and the terminal may be expressed as a second communication device. A base station (BS) may be replaced with terms including a fixed station, a Node B, an evolved-NodeB (eNB), a Next Generation NodeB (gNB), a base transceiver system (BTS), an access point (AP), a network (5G network), an AI system, a road side unit (RSU), a vehicle, a robot, an Unmanned Aerial Vehicle (UAV), an Augmented Reality (AR) device, a Virtual Reality (VR) device, and the like. Further, the terminal may be fixed or mobile and may be replaced with terms including a User Equipment (UE), a Mobile Station (MS), a user terminal (UT), a Mobile Subscriber Station (MSS), a Subscriber Station (SS), an Advanced Mobile Station (AMS), a Wireless Terminal (WT), a Machine-Type Communication (MTC) device, a Machine-to-Machine (M2M) device, and a Device-to-Device (D2D) device, the vehicle, the robot, an AI module, the Unmanned Aerial Vehicle (UAV), the Augmented Reality (AR) device, the Virtual Reality (VR) device, and the like.

### DeModulation Reference Signal (DMRS)

### DMRS Reception Procedure

A DMRS-related operation for PDSCH reception will be described.

When receiving PDSCH scheduled by DCI format 1_0 or receiving PDSCH before dedicated higher layer configuration of any of the parameters dmrs-AdditionalPosition, maxLength, and dmrs-Type, the UE assumes that the PDSCH is not present in any symbol carrying DM-RS except for PDSCH with allocation duration of 2 symbols with PDSCH mapping type B, and a single symbol front-loaded DM-RS of configuration type 1 on DM-RS port 1000 is transmitted, and that all the remaining orthogonal antenna ports are not associated with transmission of PDSCH to another UE.

In addition, for PDSCH with mapping type A, the UE assumes that dmrs-AdditionalPosition=′pos2′ and up to two additional single-symbol DM-RS are present in a slot according to the PDSCH duration indicated in the DCI. For PDSCH with allocation duration of 7 symbols for normal CP or 6 symbols for extended CP with mapping type B, the UE assumes that one additional single-symbol DM-RS is present in the 5th or 6th symbol when the front-loaded DM-RS symbol is in the 1st or 2nd symbol respectively of the PDSCH allocation duration. Otherwise, the UE assumes that the additional DM-RS symbol is not present. And, for PDSCH with allocation duration of 4 symbols with mapping type B, the UE assumes that no additional DM-RS are present. For PDSCH with allocation duration of 2 symbols with mapping type B, the UE assumes that no additional DM-RS are present, and the UE assumes that the PDSCH is present in the symbol carrying DM-RS.

When receiving the PDSCH scheduled by DCI format 1_1 by a PDCCH having CRC scrambled by C-RNTI, MCS-C-RNTI, or configured scheduling (CS)-RNTI,
The UE may be configured as a higher layer parameter drms_Type and the configured DMRS configuration type is used for receiving the PDSCH.
The UE may be configured as a maximum number of front-loaded DMRS symbols for the PDSCH by the higher layer parameter maxLength given by DMRS-DownlinkConfig.

In the UE, the number of DMRS ports may be scheduled by an antenna port index of DCI format 1_1.

The DMRS configuration type is configured by the dmrs-Type parameter in DMRS-DownlinkConfig IE of Table 1. DMRS configuration type 1 has a higher RS density in a frequency domain and supports up to 4 (8) ports for single (double)-symbol DMRS. In addition, DMRS configuration type 1 supports length-2 F-CDM and FDM for the single-symbol DMRS and supports length-2 F/T-CDM and FDM for the double-symbol DMRS. DMRS configuration type 2 has more DMRS antenna ports and supports up to 6 (12) ports for the single (double)-symbol DMRS.

Table 1 below is a table showing one example of DMRS-DownlinkConfig IE used for configuring downlink DMRS for the PDSCH.

TABLE 1
-- ASN1START
-- TAG-DMRS-DOWNLINKCONFIG-START
DMRS-DownlinkConfig ::= SEQUENCE {

| | |
|---|---|
| dmrs-Type | ENUMERATED {type2} |

OPTIONAL, -- Need S

| | |
|---|---|
| dmrs-AdditionalPosition | ENUMERATED {pos0, pos1, pos3} |

OPTIONAL, -- Need S

| | |
|---|---|
| maxLength | ENUMERATED {len2} |

OPTIONAL, -- Need S

| | |
|---|---|
| scramblingID0 | INTEGER (0..65535) |

OPTIONAL, -- Need S

| | |
|---|---|
| scramblingID1 | INTEGER (0..65535) |

OPTIONAL, -- Need S

| | |
|---|---|
| phaseTrackingRS | SetupRelease { PTRS- |
| DownlinkConfig } | OPTIONAL, -- |

Need M
...
}
-- TAG-DMRS-DOWNLINKCONFIG-STOP
-- ASN1STOP

In Table 1, parameter dmrs-AdditionalPosition represents a location for additional DM-RS in DL and when there is no corresponding parameter, the UE applies a pos2 value. Parameter Dmrs-Type represents selection of the DMRS type to be used for DL and when there is no corresponding parameter, the UE uses DMRS type 1. Parameter Max-Length represents the maximum number of OFDM symbols for DL front loaded DMRS, and len1 corresponds to a value of 1. Parameter Phase TrackingRS configures DL PTRS and when the corresponding parameter does not exist or is cancelled, the UE assumes that there is no DL PTRS.

For DM-RS configuration type 1,
when is scheduled with one codeword and antenna port mapping is allocated with indices of {2, 9, 10, 11, or 30} or the UE is scheduled with two codewords,
the UE may assume that all remaining orthogonal antenna ports are not related to transmission of the PDSCH to another UE.

For DM-RS configuration type 2,
when is scheduled with one codeword and the antenna port mapping is allocated with indices of {2, 10, 23} or the UE is scheduled with two codewords,
the UE may assume that all remaining orthogonal antenna ports are not related to transmission of the PDSCH to another UE.

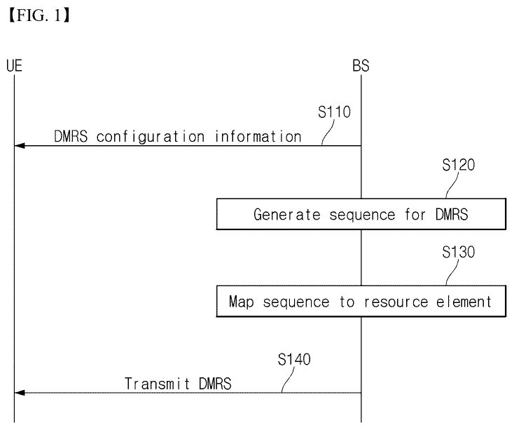

FIG. 1 is a flow chart illustrating an example of a DL DMRS procedure.

A base station transmits DMRS configuration information to a UE, in S110.

The DMRS configuration information may refer to DMRS-DownlinkConfig IE. The DMRS-DownlinkConfig IE may include parameter dmrs-Type, parameter dmrs-AdditionalPosition, parameter maxLength, parameter phaseTrackingRS, etc.

The parameter dmrs-Type is a parameter for selection of a DMRS configuration type to be used for DL. In NR, the DMRS may be classified into two configuration types: (1) DMRS configuration type 1 and (2) DMRS configuration type 2. The DMRS configuration type 1 is a type having a higher RS density in the frequency domain, and the DMRS configuration type 2 is a type having more DMRS antenna ports.

The parameter dmrs-AdditionalPosition is a parameter indicating the position of an additional DMRS in the DL. If the corresponding parameter is not present, the UE applies value of pos2. In the DMRS, a first position of a front-loaded DMRS may be determined according to the PDSCH mapping type (type A or type B), and an additional DMRS may be configured to support a high speed UE. The front-loaded DMRS occupies 1 or 2 consecutive OFDM symbols and is indicated by RRC signaling and downlink control information (DCI).

The parameter maxLength is a parameter indicating the maximum number of OFDM symbols for DL front-loaded DMRS. The parameter phaseTrackingRS is a parameter for configuring DL PTRS. If the corresponding parameter is not present or has been canceled, the UE assumes that there is no DL PTRS.

The base station generates a sequence used for DMRS, in S120.

The sequence for DMRS is generated according to Equation 1 below.

$$r ( n ) = \frac{1}{\sqrt{2}} ( 1 - 2 \cdot c ( 2 n ) ) + j \frac{1}{\sqrt{2}} ( 1 - 2 \cdot c ( 2 n + 1 ) ) \qquad [ Equation 1 ]$$

The pseudo-random sequence c(i) is defined by 3GPP TS 38.211 5.2.1. That is, c(i) may be a length-31 gold sequence using two m-sequences. A pseudo-random sequence generator is initialized by Equation 2 below.

$${c}_{init} = ( {2}^{17} ( {N}_{symb}^{slot} {n}_{s , f}^{μ} + l + 1 ) ( 2 {N}_{ID}^{{n}_{SCID}} + 1 ) + 2 {N}_{ID}^{{n}_{SCID}} + {n}_{SCID} ) mod {2}^{31} \qquad [ Equation 2 ]$$

where l is the OFDM symbol number within the slot, and

$${n}_{s , f}^{μ}$$

is the slot number within a frame.

$${N}_{ID}^{0} , {N}_{ID}^{1} ∈ \{ 0 , 1 , … , 65535 \}$$

are given by the higher-layer parameter scramblingID0 and scramblingID1, respectively, in the DMRS-DownlinkConfig IE if provided and the PDSCH is scheduled by PDCCH using DCI format 1_1 with the CRC scrambled by C-RNTI, MCS-C-RNTI, or CS-RNTI.

$${N}_{ID}^{0} ∈ \{ 0 , 1 , … , 65535 \}$$

is given by the higher-layer parameter scramblingID0 in the DMRS-DownlinkConfig IE if provided and the PDSCH is scheduled by PDCCH using DCI format 1_0 with the CRC scrambled by C-RNTI, MCS-C-RNTI, or CS-RNTI.

$${N}_{ID}^{{n}_{SCID}} = {N}_{ID}^{cell} ,$$

DMRS sequence initialization field in the DCI associated with the PDSCH transmission if DCI format 1_1 is used.

The base station maps the generated sequence to a resource element, in S130. Here, the resource element may mean including at least one of time, frequency, antenna port, or code.

The base station transmits the DMRS to the UE on the resource element, in S140. The UE receives the PDSCH using the received DMRS.

### UE DMRS Transmission Procedure

A DMRS related operation for receiving the PUSCH will be described. As described above, UL means signal transmission (or communication) from the UE to the BS. The UL DMRS related operation is similar to the DL DMRS related operation described above, and names of the parameters related to DL may be replaced with the names of parameters related to UL.

That is, DMRS-DownlinkConfig IE may be replaced with DMRS-UplinkConfig IE, the PDSCH mapping type may be replaced with a PUSCH mapping type, and the PDSCH may be replaced with the PUSCH. In addition, in the DL DMRS related operation, the BS may be replaced with the UE and the UE may be replaced with the BS. Sequence generation for the UL DMRS may be defined differently according to whether transform decoding being enabled.

More specifically, in respect to the DMRS, when cyclic prefix orthogonal frequency division multiplexing (CP-OFDM) is used (or when transform precoding is not enabled), a PN sequence is used and when Discrete Fourier Transform-spread-OFDM (DFT-s-OFDM) is used (when the transform precoding is enabled), a ZC sequence having a length of 30 or more is used.

Table 2 below is a table showing one example of DMRS-UplinkConfig IE used for configuring uplink DMRS for the PUSCH.

TABLE 2
-- ASN1START
-- TAG-DMRS-UPLINKCONFIG-START

| DMRS-UplinkConfig ::= | SEQUENCE { | |
|---|---|---|
| dmrs-Type | | ENUMERATED {type2} |

OPTIONAL, -- Need S

| | |
|---|---|
| dmrs-AdditionalPosition | ENUMERATED {pos0, pos1, pos3} |

OPTIONAL, -- Need S

| | |
|---|---|
| phaseTrackingRS | SetupRelease { PTRS- |
| UplinkConfig } | OPTIONAL, -- Need |

M

| | |
|---|---|
| maxLength | ENUMERATED {len2} |

OPTIONAL, -- Need S

| transformPrecodingDisabled | SEQUENCE { | |
|---|---|---|
| scramblingID0 | | INTEGER (0..65535) |

OPTIONAL, -- Need S

| | |
|---|---|
| scramblingID1 | INTEGER (0..65535) |

```
OPTIONAL, -- Need S
    ...
  }
OPTIONAL, -- Need R
```

| transformPrecodingEnabled | SEQUENCE { | |
|---|---|---|
| nPUSCH-Identity | | INTEGER(0..1007) |

OPTIONAL, -- Need S

| | |
|---|---|
| sequenceGroupHopping | ENUMERATED {disabled} |

OPTIONAL, -- Need S

| | |
|---|---|
| sequenceHopping | ENUMERATED {enabled} |

```
OPTIONAL, -- Need S
    ...
  }
OPTIONAL, -- Need R
  ...
}
-- TAG-DMRS-UPLINKCONFIG-STOP
-- ASN1STOP
```

In Table 2, parameter dmrs-AdditionalPosition represents a location for additional DM-RS in UL and when there is no corresponding parameter, the UE applies a pos2 value. Parameter Dmrs-Type represents selection of the DMRS type to be used for UL and when there is no corresponding parameter, the UE uses DMRS type 1.

Parameter Max-Length represents the maximum number of OFDM symbols for UL front loaded DMRS, and len1 corresponds to a value of 1. Parameter Phase TrackingRS configures UL PTRS. Parameter transformPrecodingdisabled indicates a DMRS-related parameter for Cyclic Prefix OFDM. Parameter transformPrecodingEnabled indicates DMRS-related parameters for DFT-s-OFDM (Transform Precoding).

Hereinafter, the UE DM-RS transmission procedure will be described in more detail.

When the transmitted PUSCH is neither scheduled by DCI format 0_1 with CRC scrambled by C-RNTI, CS-RNTI, or MCS-C-RNTI nor corresponds to a configured grant, the UE uses a single symbol front-loaded DM-RS of configuration type 1 on DM-RS port 0, and the remaining REs that are not used for DM-RS in the symbols are not used for any PUSCH transmission except for a PUSCH with an allocated duration of 2 or less OFDM symbols with disabled transform precoding. Additional DM-RS may be transmitted according to a scheduling type and PUSCH duration by considering whether frequency hopping is enabled.

When the frequency hopping is disabled: The UE assumes that dmrs-AdditionalPosition is equal to ‘pos2’, and up to 2 additional DM-RSs may be transmitted according to the PUSCH duration.

When the frequency hopping is enabled, the UE assumes that dmrs-AdditionalPosition is equal to ‘pos1’, and up to 1 additional DM-RSs may be transmitted according to the PUSCH duration.

When the transmitted PUSCH is scheduled by activation DCI format 0_0 with CRC scrambled by CS-RNTI, the UE uses a single symbol front-loaded DM-RS of a configuration type provided by a higher-layer parameter dmrs-Type of configuredGrantConfig on DM-RS port 0, and the remaining REs that are not used for DM-RS in the symbols are not used for any PUSCH transmission except for a PUSCH with an allocated duration of two or less OFDM symbols with disabled transform precoding, and an additional DM-RS having dmrs-AdditionalPosition from configuredGrantConfig may be transmitted based on the scheduling type and the PUSCH duration considering whether the frequency hopping is enabled.

When the transmitted PUSCH is scheduled by DCI format 0_1 having CRC scrambled by C-RNTI, CS-RNTI, or MCS-RNTI or corresponds to the configured grant,
The UE may be configured as the higher layer parameter dmrs-Type in DMRS-UplinkConfig and the configured DM-RS configuration type is used for transmitting the PDSCH.
The UE may be configured as a maximum number of front-loaded DMRS symbols for the PUSCH by the higher layer parameter maxLength in DMRS-UplinkConfig.

When the UE transmitting the PUSCH is configured as higher layer parameter phaseTrackingRS in DMRS-UplinkConfig, the UE may assume that the configurations do not simultaneously occur for the transmitted PUSCH.
Each random DM-RS port of 4-7 or 6-11 is scheduled by the UE for DM-RS configuration type 1 and type 2 and the PT-RS is transmitted from the UE.

For the PUSCH scheduled by DCI format 0_1, by activation DCI format 0_1 having the CRC scrambled by the CS-RNTI or by configured grant type 1 configuration, the UE assumes that a DM-RS CDM group is not used for data transmission.

### Phase Tracking Reference Signal (PTRS)

In the 5G NR standard, Phase-tracking reference signal (PTRS) was introduced to compensate for impairment caused by phase noise in A high-frequency band. The phase noise causes common phase error (CPE) and inter-carrier interference (ICI) in the frequency domain.

Hereinafter, the DL PTRS and UL PTRS related operations will be described in detail.

### DL PTRS Related Operation

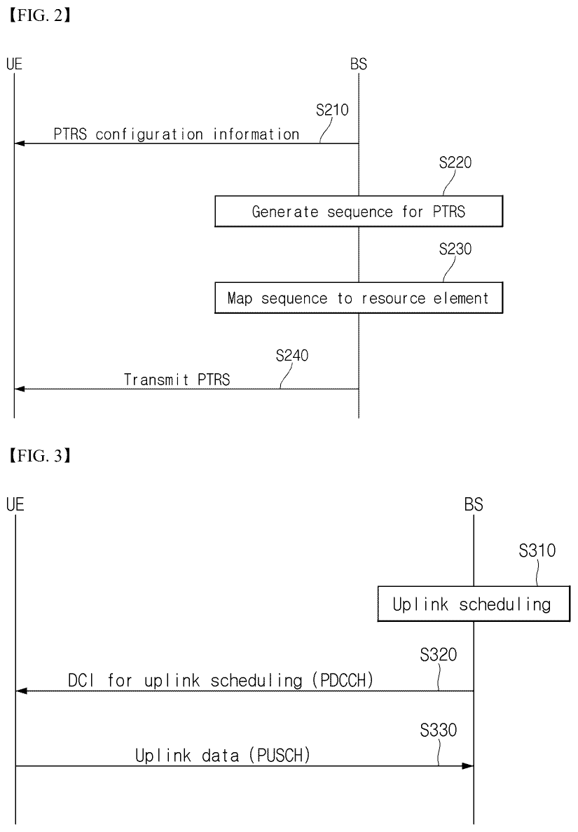

FIG. 2 is a flow chart illustrating an example of a DL PTRS procedure.

A base station transmits PTRS configuration information to a UE, in S210. The PTRS configuration information may refer to PTRS-DownlinkConfig IE. The PTRS-DownlinkConfig IE may include frequencyDensity parameter, timeDensity parameter, epre-Ratio parameter, resourceElementOffset parameter, etc.

The frequencyDensity parameter is a parameter representing a presence and a frequency density of a DL PTRS as a function of scheduled BW. The timeDensity parameter is a parameter representing the presence and a time density of the DL PTRS as a function of modulation and coding scheme (MCS). The epre-Ratio parameter is a parameter representing an energy per resource element (EPRE) between a PTRS and a PDSCH.

The base station generates a sequence used for the PTRS, in S220. As shown in Equation 3 below, the sequence for the PTRS is generated using a DMRS sequence of the same subcarrier. The sequence generation for the PTRS may be differently defined depending on whether transform precoding has been enabled, and Equation 3 below represents an example where the transform precoding is disabled.

$${r}_{k} = r ( 2 m + {k}^{′} ) \qquad [ Equation 3 ]$$

Here, r(2m+k′) is a DMRS given in a location l₀ and a subcarrier k.

That is, the sequence of the PTRS uses a sequence of the DMRS, and more specifically, the sequence of the PTRS in the subcarrier k is the same as a sequence of the DMRS in the subcarrier k.

The base station maps the generated sequence to a resource element, in S230. Here, the resource element may mean including at least one of time, frequency, antenna port or code.

A location of the PTRS in the time domain starts from a starting symbol of PDSCH allocation and is mapped at a specific symbol spacing. If a DMRS symbol is present, the mapping is performed from a symbol next to the DMRS symbol. The specific symbol spacing may be 1, 2 or 4 symbols.

A frequency location of the PTRS in relation to resource element mapping of the PTRS is determined by a frequency location of an associated DMRS port and higher layer parameter UL-PTRS-RE-offset. Here, UL-PTRS-RE-offset is included in PTRS configuration and indicates a subcarrier offset for UL PTRS for CP-OFDM.

For DL, the PTRS port is related to a DMRS port of a lowest index among scheduled DMRS ports. And, for UL, the base station configures which DMRS port is related to the PTRS port via UL DCI.

The base station transmits the PTRS to the UE on a resource element, in S240.

### UL PTRS Related Operation

An UL PTRS related operation is similar to the DL PTRS related operation mentioned above, and the names of the parameters related to the DL PTRS may be replaced by the names of the parameters related to the UL PTRS. That is, PTRS-DownlinkConfig IE may be replaced by PTRS-UplinkConfig IE, and in the DL PTRS related operation, the base station may be replaced by the UE and the UE may be replaced by the base station. In the same manner, the sequence generation for the PTRS may be differently defined depending on whether transform precoding has been enabled.

### Downlink Transmission and Reception Operations

The eNB may schedule downlink transmission such as the frequency/time resource, the transport layer, a downlink precoder, the MCS, etc. Specifically, the eNB may determine a beam for PDSCH transmission to the UE.

In addition, the UE may receive Downlink Control Information (DCI) for downlink scheduling (i.e., including scheduling information of the PDSCH) on the PDCCH (S702). DCI format 1_0 or DCI format 1_1 may be used for the downlink scheduling and specifically, DCI format 1_1 may include information such as the following examples: Identifier for DCI formats, Bandwidth part indicator, Frequency domain resource assignment, Time domain resource assignment, PRB bundling size indicator, Rate matching indicator, ZP CSI-RS trigger, Antenna port(s), Transmission configuration indication (TCI), SRS request, and Demodulation Reference Signal (DMRS) sequence initialization.

In particular, according to each state/index indicated in an antenna port(s) field, the number of DMRS ports may be scheduled, and single-user (SU)/multi-user (MU) transmission scheduling is also available. Specifically, the order of DMRS ports corresponding to the number of CWs may be predefined depending on dmrs-type and maxLength, and the number and/or order of DMRS ports may be indicated via an antenna port field of DCI.

In addition, the TCI field consists of 3 bits, and the QCL for the DMRS may be dynamically indicated by indicating a maximum of 8 TCI states according to the TCI field value. The UE may receive downlink data from the base station on the PDSCH. When the UE detects a PDCCH including DCI format 1_0 or 1_1, the UE may decode the PDSCH according to an indication by the corresponding DCI.

Here, when the UE receives a PDSCH scheduled by DCI format 1_1, a DMRS configuration type may be configured by higher layer parameter “dmrs-Type” in the UE and the DMRS configuration type is used for receiving the PDSCH. Further, in the UE, the maximum number of front-loaded DMRS symbols for the PDSCH may be configured by higher layer parameter “maxLength.”

In the case of DMRS configuration type 1, when a single codeword is scheduled and an antenna port mapped to an index of {2, 9, 10, 11, or 30} is designated in the UE or when two codewords are scheduled in the UE, the UE assumes that all remaining orthogonal antenna ports are not associated with PDSCH transmission to another UE. Alternatively, in the case of DMRS configuration type 2, when a single codeword is scheduled and an antenna port mapped to an index of {2, 10, or 23} is designated in the UE or when two codewords are scheduled in the UE, the UE assumes that all remaining orthogonal antenna ports are not related to PDSCH transmission to another UE.

### Uplink Transmission/Reception Operation

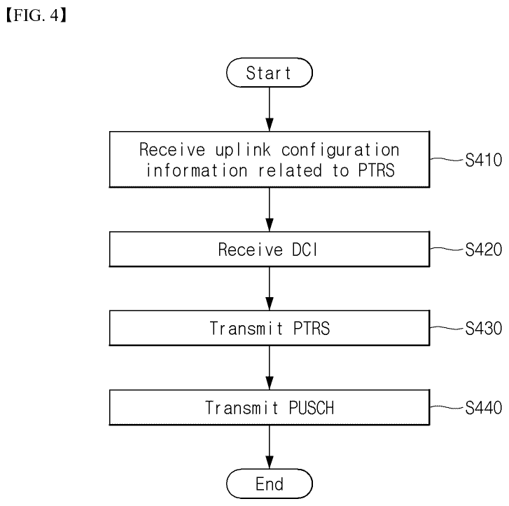

FIG. 3 illustrates an example of an uplink transmission and reception operation. Referring to the FIG. 3, the eNB may schedule uplink transmission such as the frequency/time resource, the transport layer, an uplink precoder, the MCS, etc., (S301). In particular, the eNB may determine a beam for PUSCH transmission of the UE through the beam management operations described above. And, the UE may receive, from the eNB, DCI for uplink scheduling (i.e., including scheduling information of the PUSCH) on the PDCCH (S302).

DCI format 0_0 or 0_1 may be used for the uplink scheduling and in particular, DCI format 0_1 may include information such as the following examples: Identifier for DCI formats, UL/Supplementary uplink (SUL) indicator, Bandwidth part indicator, Frequency domain resource assignment, Time domain resource assignment, Frequency hopping flag, Modulation and coding scheme (MCS), SRS resource indicator (SRI), Precoding information and number of layers, Antenna port(s), SRS request, DMRS sequence initialization, and Uplink Shared Channel (UL-SCH) indicator.

In particular, configured SRS resources in an SRS resource set associated with higher layer parameter “usage” may be indicated by an SRS resource indicator field. Further, “spatialRelationInfo” may be configured for each SRS resource and a value of “spatialRelationInfo” may be one of {CRI, SSB, and SRI}.

In addition, the UE may transmit the uplink data to the eNB on the PUSCH (S303). When the UE detects a PDCCH including DCI format 0_0 or 0_1, the UE may transmit the corresponding PUSCH according to the indication by the corresponding DCI. two schemes (Codebook based transmission scheme and non-codebook based transmission scheme) are supported for PUSCH transmission.

In the case of the codebook based transmission, when higher layer parameter txConfig” is set to “codebook”, the UE is configured to the codebook based transmission. On the contrary, when higher layer parameter txConfig” is set to “nonCodebook”, the UE is configured to the non-codebook based transmission. When higher layer parameter “txConfig” is not configured, the UE does not predict that the PUSCH is scheduled by DCI format 0_1. When the PUSCH is scheduled by DCI format 0_0, the PUSCH transmission is based on a single antenna port. In the case of the codebook based transmission, the PUSCH may be scheduled by DCI format 0_0, DCI format 0_1, or semi-statically. When the PUSCH is scheduled by DCI format 0_1, the UE determines a PUSCH transmission precoder based on the SRI, the Transmit Precoding Matrix Indicator (TPMI), and the transmission rank from the DCI as given by the SRS resource indicator and the Precoding information and number of layers field. The TPMI is used for indicating a precoder to be applied over the antenna port and when multiple SRS resources are configured, the TPMI corresponds to the SRS resource selected by the SRI. Alternatively, when the single SRS resource is configured, the TPMI is used for indicating the precoder to be applied over the antenna port and corresponds to the corresponding single SRS resource. A transmission precoder is selected from an uplink codebook having the same antenna port number as higher layer parameter “nrofSRS-Ports”. When the UE is set to higher layer parameter “txConfig” set to “codebook”, at least one SRS resource is configured in the UE. An SRI indicated in slot n is associated with most recent transmission of the SRS resource identified by the SRI and here, the SRS resource precedes PDCCH (i.e., slot n) carrying the SRI.

In the case of the non-codebook based transmission, the PUSCH may be scheduled by DCI format 0_0, DCI format 0_1, or semi-statically. When multiple SRS resources are configured, the UE may determine the PUSCH precoder and the transmission rank based on a wideband SRI and here, the SRI is given by the SRS resource indicator in the DCI or given by higher layer parameter “srs-ResourceIndicator”. The UE may use one or multiple SRS resources for SRS transmission and here, the number of SRS resources may be configured for simultaneous transmission in the same RB based on the UE capability. Only one SRS port is configured for each SRS resource. Only one SRS resource may be configured to higher layer parameter “usage” set to “nonCodebook”. The maximum number of SRS resources which may be configured for non-codebook based uplink transmission is 4. The SRI indicated in slot n is associated with most recent transmission of the SRS resource identified by the SRI and here, the SRS transmission precedes PDCCH (i.e., slot n) carrying the SRI.

### Multi-Transmission/Reception Point (TRP) Related Operation

An M-TRP transmission scheme in which M TRPs transmit data to one user equipment (UE) may be largely divided into two types, eMBB M-TRP transmission which is a scheme for increasing a transmission rate and URLLC M-TRP transmission which is a scheme for increasing a reception success rate and reducing latency.

Hereinafter, in the methods proposed in the present disclosure, DL MTRP-URLLC means that multiple TRPs transmit the same data/DCI using multiple TRPs by using different layer/time/frequency resources. For example, TRP 1 transmits the same data/DCI in resource 1 and TRP 2 transmits the same data/DCI in resource 2. A UE configured with the DL MTRP-URLLC transmission scheme receives the same data/DCI using different layer/time/frequency resources. At this time, the UE is instructed by the BS which QCL RS/type (i.e., DL TCI state) to use in the layer/time/frequency resources receiving the same data/DCI. For example, when the same data/DCI is received from resource 1 and resource 2, the DL TCI state used by resource 1 and the DL TCI state used by resource 2 are indicated. High reliability may be achieved because the UE receives the same data/DCI through both Resource 1 and Resource 2. The DL MTRP URLLC may be applied to PDSCH/PDCCH.

Conversely, UL MTRP-URLLC means that multiple TRPs receive the same data/UCI from one UE using different layer/time/frequency resources. For example, TRP 1 receives the same data/UCI from UE in resource 1, and TRP 2 receives the same data/UCI from UE in resource 2, and then shares the received data/UCI through the backhaul link connected between TRPs. A UE configured with the UL MTRP-URLLC transmission scheme transmits the same data/DCI using different layer/time/frequency resources. At this time, the UE is instructed by the BS which Tx beam and which Tx power (i.e., UL TCI state) to use in the layer/time/frequency resources transmitting the same data/DCI. For example, when the same data/UCI is transmitted in resource 1 and resource 2, the UL TCI state used by resource 1 and the UL TCI state used by resource 2 are indicated. The UL MTRP URLLC may be applied to PUSCH/PUCCH.

### SDCI or MDCI Based MTRP Transmission

Further, in terms of downlink control information (DCI) transmission, the multiple (M)-TRP transmission scheme may be divided into i) a multiple (M)-DCI based M-TRP transmission scheme in which each TRP transmits different DCI and ii) a single(S)-DCI based M-TRP transmission scheme in which one TRP transmits the DCI. As an example, in the case of the S-DCI, since all scheduling information for data transmitted by M TRPs should be delivered through one DCI, the S-DCI may be used in an ideal backhaul (BH) environment in which two TRPs may be dynamically coordinated with each other.

### R16 NR MTRP Transmission

The R16 NR standard supports S-DCI based MTRP PDSCH and M-DCI based MTRP PDSCH transmission schemes.

### R16 M-DCI Based MTRP PDSCH

M-DCI based MTRP PDSCH transmission is a scheme in which each TRP schedules and transmits PDSCH through DCI. That is, TRP 1 transmits PDSCH 1 through DCI 1, and TRP 2 transmits PDSCH 2 through DCI 2. When PDSCH 1 and PDSCH 2 overlap in the same frequency time resource, two PDSCHs are received for the same RE, which increases resource efficiency and increases a transmission capacity. To this end, the R16 standard introduces a CORESET pool, which is a group of multiple CORESETs, and TRP 1 transmits the PDCCH through a CORESET belonging to CORESET pool 0, and the PDSCH scheduled by the corresponding PDCCH is transmitted by TRP 1. TRP 2 transmits the PDCCH through a CORESET belonging to CORESET pool 1, and the PDSCH scheduled by the PDCCH is transmitted by TRP 2. Specific TRP may also schedule PUSCH transmission to the UE through a CORESET belonging to each COERSET pool. In respect to the PUCCH, TRP 1 schedules some PUCCH resources to receive the UCI, and TRP 2 schedules remaining PUCCH resources to receive the UCI. In the case of the PUSCH or the PUCCH, channels scheduled/used by each TRP are TDMed with each other, and overlapping does not occur, so an increase in transmission capacity may not be anticipated, but the UE may transmit independent PUSCHs/PUCCHs to TRPs 1 and 2.

Further, the UE may recognize PUSCH (or PUCCH) scheduled by DCI received by different CORESETs (or CORESETs which belong to different CORESET groups) as PUSCH (or PUCCH) transmitted to different TRPs or PUSCH (or PUCCH) of different TRPs. Further, a scheme for UL transmission (e.g., PUSCH/PUCCH) transmitted to different TRPs may be applied equally even to UL transmission (e.g., PUSCH/PUCCH) transmitted to different panels which belong to the same TRP.

### R17 NR MTRP Transmission

The R17 NR standard supports MTRP PDCCH repeat transmission, MTRP PDCCH/PDSCH SFN transmission, S-DCI based MTRP PUSCH repeat transmission, and single PUCCH resource based MTRP PUCCH repeat transmission. All of these transmission techniques repeatedly transmit the same contents (i.e., DCI or UL TB or UCI) with URLLC target enhancement to increase reliability. In case of MTRP PDCCH repeat transmission, the MTRP PDCCHs are TDM or FDM, and repeatedly transmitted, MTRP PDCCH/PDSCH SFN is repeatedly transmitted in the same time/frequency/layer, in S-DCI based MTRP PUSCH repeat transmission, S-DCI based MTRP PUSCH is TDM and repeatedly transmitted, and in single PUCCH resource based MTRP PUCCH repeat transmission, single PUCCH resource based MTRP PUCCH is TDM and repeatedly transmitted.

### R17 MTRP SFN PDCCH

As a special case of MTRP PDCCH repeat transmission, multiple TRPs may repeatedly transmit the same DCI through the same time/frequency/DMRS port, and this may be called SFN PDCCH transmission. However, for SFN PDCCH transmission, the BS configures multiple TCI states in one CORESET instead of configuring multiple CORESETs in which different TCI states are configured. When the UE receives a PDCCH candidate through an SS set connected to one CORESET, the UE performs channel estimation of the PDCCH DMRS using all of the multiple TCI states and attempts decoding.

### R17 MTRP SFN PDSCH

When the MTRP PDSCH is repeatedly transmitted, the two TRPs repeatedly transmit the corresponding channel on different resources. However, as a special case, even when two TRPs use the same resource, that is, when two TRPs repeatedly transmit the same channel through same frequency, time, and layer (=DMRS port), the reliability of the corresponding channel may be enhanced. In this case, resources are not distinguished in the same channel which is repeatedly transmitted, so the resources are collected and received in air, and a receiver recognized the channels as one channel. In the R17 NR standard, two DL TCI states may be configured for PDSCH DMRS reception for PDSCH SFN transmission.

For convenience of explanation, the present disclosure is applied to the proposed scheme by assuming cooperative transmission/reception between 2 TRPs, but is extensively applicable to an environment of multi TRPs of 3 or more and also extensively applicable to a multi-panel environment. Different TRPs can be recognized as different TCI states to the UE, and a case where the UE receives/transmits data/DCI/UCI using TCI state 1 means receiving/transmitting the data/DCI/UCI from/to TRP 1.

In the present disclosure, Transmission Occasion (TO) means each channel transmitted at a different time when multiple channels are TDMed, each channel transmitted on a different frequency/RB when multiple channels are FDMed, and each channel transmitted on a different layer/beam/DMRS port when multiple channels are SDMed. One TCI state is applied to each TO. When the same channel is repeatedly transmitted, a complete DCI/data/UCI is transmitted in one TO, and the receiver receives multiple TOs to increase a reception success rate.

### R17 SDCI Based Multi-TB PUSCH/PDSCH Scheduling

In R17 NR, a scheme is supported in which a single DCI schedules multiple PUSCH/PDSCH simultaneously in an ultra-high frequency band (beyond 5.26 GHz). For example, multiple TDRAs (=TOs) may be indicated at once through the TDRA field of the PUSCH scheduling DCI, and different TBs are transmitted for each TO through the PUSCH. FDRA, MCS, TPMI, and SRI values of the DCI are commonly applied to multiple scheduled TBs. Further, NDI and RV for each TB are individually indicated through the DCI, and a HARQ number is indicated as a single value, but increases sequentially in a TO order based on an initial TO.

### Simultaneous Transmission Across Multi-Panels (STxMP) Related Description

In R18, a method in which the UE simultaneously multiple channels/RSs of the same type or a method in which the same UE simultaneously transmits multiple channels/RSs of different types is discussed. In the case of an existing UE, an operation of transmitting multiple channels/RSs at one time is restricted (e.g., it is possible to simultaneously transmit multiple SRS resources of different SRS sets for UL beam measurement, but it is impossible to simultaneously transmit multiple PUSCHs), but an advanced UE in the future will be able to ease these restrictions and simultaneously transmit multiple channels or RSs using multiple transmission panels, and the UE is called STxMP UE. For example, two PUSCHs corresponding to two UL TBs are scheduled on the same RE, and Spatial relation RS 1 and PC parameter Set 1 (i.e., UL TCI state 1) and Spatial relation RS 2 and PC parameter Set 2 (i.e., UL TCI state 2) are configured for PUSCH 1 and 2 transmission, respectively. The UE transmits PUSCH 1 using panel 1 corresponding to UL TCI state 1 and at the same time, transmits PUSCH 2 using panel 2 corresponding to UL TCI state 2.

When the base station schedules the PUSCH through the DCI, the BS may indicate whether to transmit the PUSCH in STxMP, whether to transmit the PUSCH by a single panel, whether to perform MTRP PUSCH repeat transmission, etc. Of course, the UE must have an STxMP capability and an STxMP mode must be enabled in advance through RRC signaling, etc. For this purpose, an existing SRS resource set indication field may be redefined and used, or a new DCI field may be introduced.

### Unified TCI Framework Related Description

In R17, the UL TCI state may also be indicated in addition to the DL DCI state through a DL DCI (e.g., DCI format 1-1 or 1-2), or only the UL TCI state may be indicated without indicating the DL TCI state. As a result, the schemes used in the existing R15/R16 to configure UL beam and power control (PC) are replaced in R17 with the UL TCI state indication method. More specifically, in R17, one UL TCI state may be indicated through the TCI field of DL DCI, and the UL TCI state may be applied to all PUSCHs and all PUCCHs after a predetermined time called beam application time, and may be applied to some or all of the indicated SRS resource sets. In R18, a scheme to indicate multiple UL TCI states (and/or DL TCI states) through the TCI field of DL DCI is under discussion.

The contents (the DMRS, the PTRS, the UL transmission/reception operation, the MTRP related operation, etc.) described above may be applied in combination with methods proposed in the present disclosure to be described below or may be supplemented to clarify technical features of the methods proposed in the present disclosure. Methods to be described below are just distinguished for convenience and it is needless to say that some components of any one method may be substituted with some components of another method or may be applied in combination with each other.

In the present disclosure, ‘port’ and ‘antenna port’ may be interpreted as the same meaning. For example, PTRS (DMRS) port means PTRS (DMRS) antenna port, and vice versa.

In the present disclosure, ‘DMRS (or PTRS)’ may mean ‘DM-RS (or PT-RS)’ and vice versa.

Conventionally, up to two PTRS ports may be supported (e.g., maxNrofPorts is set to n1 or n2). Referring to Table 3 below, in Release 18, 8 Tx ports may be supported for uplink transmission of the UE. Hence, up to four PTRS ports may be supported (e.g., maxNrofPorts is set to n1, n2, n3 or n4).

TABLE 3
Agreement
For support of more than 4 layers SU-MIMO PUSCH, study the following
potential enhancements for PTRS-DMRS association.

| | |
|---|---|
| - | Whether to support more than 2-port UL PTRS. |
| - | Whether to increase the DCI size of PTRS-DMRS association field in |
| | DCI format 0_1/0_2. |

#110bis-e DMRS FL proposal#3.3:
• For 8Tx PUSCH, support up to 4 ports PTRS for CP-OFDM.

As the number of PTRS ports increases, the RS overhead (total time/frequency density) may increase excessively compared to the existing method. Embodiments for solving the problem are described in proposals 1 to 6 below. The proposals 1 to 3 are embodiments related to a time density, and the proposals 4 to 6 are embodiments related to a frequency density.

Embodiments described below are described based on a UE PT-RS transmission procedure (UL PTRS). This is for convenience of explanation and is not intended to limit embodiments of the present disclosure to those applicable to the UL PTRS. Specifically, embodiments described below can be equally applied to a PT-RS reception procedure (DL PTRS).

### <Proposal 1>

A method of expanding the criterion that increases based on a threshold (time density threshold) of the MCS may be considered. Here, ‘expansion of the criterion that increases based on the threshold of the MCS’ means changing a value of LPT-RS defined in Table 4 for determining a time density to an increased value.

According to the existing method (e.g., Tables 4 to 6 below), the time density/frequency density may be determined as follows.

Referring to Tables 4 and 6, the time density may be determined based on a comparison between time density thresholds (e.g., ptrs-MCS1 to ptrs-MCS4) and scheduled MCS (e.g., MCS indexes indicated via DCI, IMCS of Table 4). For example, based on IMCS being greater than or equal to ptrs-MCS1 and being less than ptrs-MCS2, the time density may be determined as 4. Here, IMCS denotes an MCS index indicated based on a modulation and coding scheme (MCS) field of DCI. When the time density is 4, it means that the PTRS is mapped to each symbol every four symbols within a resource region allocated to PUSCH. For example, if a first symbol of the PTRS is symbol index 4, a second symbol of the PTRS may be symbol index 8. In other words, the time density may mean a difference (e.g., L_{PT-RS}=4) between a PTRS symbol index (e.g., 4) and the next PTRS symbol index (e.g., 8). The time density may also mean a difference between a last DMRS symbol index and a first PTRS symbol index.

Referring to Tables 5 and 6, the frequency density may be determined based on a comparison between frequency thresholds (e.g., N_{RB0} to N_{RB1}) and a scheduled bandwidth (e.g., the number of resource blocks, N_{RB} of Table 5). For example, based on N_{RB} being greater than or equal to N_{RB0} and being less than N_{RB1}, the frequency density may be determined as 2. If the frequency density is 2, it means that the PTRS is present every two RBs. The frequency density may mean an interval between a subcarrier to which the PTRS is mapped in one RB and a subcarrier to which the PTRS is mapped in another RB within a resource region allocated to PUSCH. Specifically, when an index of a specific subcarrier to which the PTRS is mapped is k1, the PTRS may be mapped to subcarriers (e.g.,

$$k 2 = k 1 + {2}^{*} {N}_{SC}^{RB}$$

(the number of subcarriers per RB)) after two RBs from the subcarrier index k1.

Referring to Table 6, some (i.e., ptrs-MCS1 to ptrs-MCS3) of the time density thresholds may be configured based on parameter timeDensity. The frequency thresholds (N_{RB0} and N_{RB1}) may be configured based on parameter frequencyDensity. If the parameter timeDensity is not configured, L_{PT-RS}=1 is assumed. If the parameter frequencyDensity is not configured, K_{PT-RS}=2 is assumed.

TABLE 4
Table 6.2.3.1-1: Time density of PT-RS
as a function of scheduled MCS

| Scheduled MCS | Time density (L_{PT-RS}) |
|---|---|
| I_{MCS} < ptrs-MCS₁ | PT-RS is not present |
| ptrs-MCS1 ≤ I_{MCS} < ptrs-MCS2 | 4 |
| ptrs-MCS2 ≤ I_{MCS} < ptrs-MCS3 | 2 |
| ptrs-MCS3 ≤ I_{MCS} < ptrs-MCS4 | 1 |

TABLE 5
Table 6.2.3.1-2: Frequency density of PT-RS
as a function of scheduled bandwidth

| Scheduled bandwidth | Frequency density (K_{PT-RS}) |
|---|---|
| N_{RB} < N_{RB0} | PT-RS is not present |
| N_{RB0} ≤ N_{RB} < N_{RB1} | 2 |
| N_{RB1} ≤ N_{RB} | 4 |

TABLE 6
38.214 section 6.2.3.1

The higher layer parameter PTRS-UplinkConfig provides the parameters ptrs-MCSᵢ,
i=1,2,3 and with values in 0-29 when MCS Table 5.1.3.1-1 or Table 5.1.3.1-3 is
used and 0-28 when MCS Table 5.1.3.1-2 is used, respectively. ptrs-MCS4 is not
explicitly configured by higher layers but assumed 29 when MCS Table 5.1.3.1-1
or Table 5.1.3.1-3 is used and 28 when MCS Table 5.1.3.1-2 is used. The higher
layer parameter PTRS-UplinkConfig provides the parameters N_{RBi} i=0,1 with values
in range 1-276.
If the higher layer parameter PTRS-UplinkConfig indicates that the time density
thresholds ptrs-MCSᵢ = ptrs-MCSᵢ₊₁, then the time density L_{PTRS} of the associated
row where both these thresholds appear in Table 6.2.3.1-1 is disabled. If the higher
layer parameter frequencyDensity in PTRS-UplinkConfig indicates that the
frequency density thresholds N_{RB,i} = N_{RB,i+1}, then the frequency density K_{PTRS} of the
associated row where both these thresholds appear in Table 6.2.3.1-2 is disabled.
If either or both of the parameters PT-RS time density (L_{PT-RS}) and PT-RS frequency
density (K_{PT-RS}), shown in Table 6.2.3.1-1 and Table 6.2.3.1-2, indicates that are
configured as ‘PT-RS not present’, the UE shall assume that PT-RS is not present.
When a UE is scheduled to transmit PUSCH with allocation duration of 2 symbols
or less, and if L_{PT-RS} is set to 2 or 4, the UE shall not transmit PT-RS. When a UE is
scheduled to transmit PUSCH with allocation duration of 4 symbols or less, and if
L_{PT-RS} is set to 4, the UE shall not transmit PT-RS.

PTRS-UplinkConfig information element
-- ASN1START
-- TAG-PTRS-UPLINKCONFIG-START

| | |
|---|---|
| PTRS-UplinkConfig ::= | SEQUENCE { |
| transformPrecoderDisabled | SEQUENCE { |
| frequencyDensity | SEQUENCE (SIZE (2)) OF |
| INTEGER (1..276) | OPTIONAL, -- Need S |
| timeDensity | SEQUENCE (SIZE (3)) OF |
| INTEGER (0..29) | OPTIONAL, -- Need S |
| maxNrofPorts | ENUMERATED {n1, n2}, |
| resourceElementOffset | ENUMERATED {offset01, |
| offset10, offset11 } | OPTIONAL, -- Need S |
| ptrs-Power | ENUMERATED {p00, p01, p10, |

p11}
}

| | |
|---|---|
| OPTIONAL, | -- Need R |
| transformPrecoderEnabled | SEQUENCE { |
| sampleDensity | SEQUENCE (SIZE (5)) OF |

INTEGER (1..276),

| | |
|---|---|
| timeDensityTransformPrecoding | ENUMERATED {d2} |
| OPTIONAL | -- Need S |

}

| | |
|---|---|
| OPTIONAL, | -- Need R |

...
}
PTRS-UplinkConfig field descriptions
frequencyDensity
Presence and frequency density of UL PT-RS for CP-OFDM waveform as a
function of scheduled BW If the field is absent, the UE uses K_PT-RS = 2 (see TS
38.214 [19], clause 6.1).
maxNrofPorts
The maximum number of UL PTRS ports for CP-OFDM (see TS 38.214 [19],
clause 6.2.3.1).
ptrs-Power
UL PTRS power boosting factor per PTRS port (see TS 38.214 [19], clause 6.1,
table 6.2.3.1.3).
resourceElementOffset
Indicates the subcarrier offset for UL PTRS for CP-OFDM. If the field is absent,
the UE applies the value offset00 (see TS 38.211 [16], clause 6.4.1.2.2).
sampleDensity
Sample density of PT-RS for DFT-s-OFDM, pre-DFT, indicating a set of
thresholds T={NRBn, n=0,1,2,3,4}, that indicates dependency between presence
of PT-RS and scheduled BW and the values of X and K the UE should use
depending on the scheduled BW, see TS 38.214 [19], clause 6.1, table 6.2.3.2-1.
timeDensity
Presence and time density of UL PT-RS for CP-OFDM waveform as a function of
MCS If the field is absent, the UE uses L_PT-RS = 1 (see TS 38.214 [19], clause
6.1).
timeDensityTransformPrecoding
Time density (OFDM symbol level) of PT-RS for DFT-s-OFDM. If the field is
absent, the UE applies value d1 (see TS 38.214 [19], clause 6.1).
transformPrecoderDisabled
Configuration of UL PTRS without transform precoder (with CP-OFDM).
transformPrecoderEnabled
Configuration of UL PTRS with transform precoder (DFT-S-OFDM).

If up to 4 PT-RS ports are supported in UL 8Tx UE in Release 18, the frequency density & time density configurations are required based on the increased ports. That is, a method and device for density reduction are required considering an increase in the number of ports. In the present disclosure, the ‘density reduction’ does not mean the time/frequency density determined based on Tables 4 and 5, and means ‘reduction of RS overhead which is the total density’ when PTRS is mapped to a physical resource based on the time/frequency density. For example, if the time density (L_{PT-RS}) is determined to be a value greater than the value defined in Table 4, the RS overhead may be reduced in the time domain. For example, if the frequency density (K_{PT-RS}) is determined to be a value greater than the value defined in Table 5, the RS overhead may be reduced in the frequency domain. Hereinafter, the reduction of density related to the technical task can be interpreted/replaced with the reduction of RS overhead.

To solve the problem in which the RS overhead increases as the number of PTRS ports increases as described above, the following embodiment may be considered.

If the maximum number of PTRS ports is set to 2 or less (e.g., if maxNrofPorts is set to n1 or n2), the time density/frequency density may be determined based on the existing method (Tables 4 to 6).

If the maximum number of PTRS ports is set to 3 or 4 or less (e.g., if maxNrofPorts is set to n3 or n4), the time density/frequency density may be determined (as a larger value) so that all the PT-RS density (RS overhead) is reduced. However, it may be assumed that the maximum number of PTRS ports configured via RRC is different from the actual number of PTRS ports (e.g., the maximum number of PTRS ports is 4, and the actual number of PTRS ports is 3 or less). In this case, conditions of the time/frequency density for reducing the RS overhead (or the value of time/frequency density defined in Table) may also be changed.

According to an embodiment, a method of applying a larger value to the time density (L_{PT-RS}) determined based on a threshold of MCS may be considered. That is, if PT-RS is configured based on a larger time density than before (if the PT-RS is mapped in the time domain), PT-RS density (RS overhead) in the time domain can be reduced compared to the existing method.

As the number of ports increases twice, a region where PTRS is mapped in the time domain may be set to half. Specifically, L_{PT-RS} (1, 2, 4) defined in Table 4 may be set to twice (2, 4, 8) the value. In this case, the configured PTRS may have the same RS overhead as before.

This is described using an example where 4 PT-RS ports are configured and ptrs-MCS2←I_{MCS}<ptrs-MCS3. According to the existing method (Table 4), the time density may be determined as 2. According to the present embodiment, the time density may be determined as 4 (which is twice the existing defined value).

The time density may be determined as a different value per the maximum number of PTRS ports.

For example, if the maximum number of PTRS ports is 3, the time density may be determined as a value (e.g., 2, 4, 8) which is twice the value defined in Table 4 so that the density (RS overhead) is ½ compared to when the maximum number of PTRS ports is 1 or 2.

For example, if the maximum number of PTRS ports is 4, the time density may be determined as a value (e.g., 3, 6, 12) which is three times the value defined in Table 4 so that the density (RS overhead) is ⅓ compared to when the maximum number of PTRS ports is 1 or 2. A reduction ratio (X=½, Y=⅓) of the density per the maximum number of PTRS ports is an example, and the corresponding value may be configured to the UE by the base station. For example, if a value of X for the maximum number of PTRS ports of 3 is set to ¼, the time density may be determined as a value (e.g., 4, 8, 16) that is four times the value defined in Table 4. For example, if a value of Y for the maximum number of PTRS ports of 4 is set to ⅕, the time density may be determined as a value (e.g., 5, 10, 20) that is five times the value defined in Table 4. The base station may configure, to the UE, a multiple value (e.g., 2, 3) corresponding to the value of X/Y, not the value of X/Y (e.g. ½ and ⅓).

Table 7 below is a table for applying the values (L_{PT-RS}) defined in Table 4 by doubling them.

TABLE 7
Table 6.2.3.1-1: Time density of PT-RS
as a function of scheduled MCS

| Scheduled MCS | Time density (L_{PT-RS}) |
|---|---|
| I_{MCS} < ptrs-MCS₁ | PT-RS is not present |
| ptrs-MCS1 ≤ I_{MCS} < ptrs-MCS2 | 8 |
| ptrs-MCS2 ≤ I_{MCS} < ptrs-MCS3 | 4 |
| ptrs-MCS3 ≤ I_{MCS} < ptrs-MCS4 | 2 |

Table 7 is only an example of showing values of the time density applied based on the present embodiment, and does not necessarily mean that a new table shall be defined to apply the values of the time density according to the present embodiment. For example, a new table is not defined, and the values (e.g., 1, 2, 4) defined in the existing Table (Table 4) may be changed to other values and applied based on the present embodiment. For example, a table (e.g., Table 7) for applying the time density according to the present embodiment may be defined separately from the existing Table.

Embodiments described below may be applied in the same manner as described above. For example, for the application of embodiments described below, a new Table (e.g., Tables 8 to Table 10) may be defined, or the values defined in the existing Table may be changed to other values and applied based on each embodiment.

### <Proposal 2>

A method of limiting the PTRS ports, to which the embodiment defined in the proposal 1 is applied, to a specific port (PTRS port 3/4 or the third/fourth PTRS port) may be considered. Specifically, the time density for port 1 and/or port 2 (the first PTRS port and/or the second PTRS port) may be determined based on the existing method (Table 4). In other words, the same time density as before may be utilized up to the first two PTRS ports.

When port 3 and/or port 4 are configured, the time density for the third/fourth PTRS port may be determined based on the proposal 1 described above so as to reduce RS overhead. That is, PTRS ports 1 & 2 may be configured based on the time density determined based on the existing method, and PTRS ports 3 & 4 may be configured based on the time density determined based on an embodiment (e.g., proposal 1) for reducing the RS overhead.

For example, the time density for PTRS ports 3 & 4 may be determined as a value (e.g., 2, 4, 8) applying a multiple of the value defined in Table 4. For example, the time density for PTRS ports 3 & 4 may use values other than the value applying the multiple of the value defined in Table 4. Specifically, the time density for PTRS ports 3 & 4 may be determined as a value separately configured by the base station to the UE.

PT-RS ports 1 and 2 (or 0 and 1) and PT-RS ports 3 and 4 (or 2 and 3) may be configured to be distinguished based on even-numbered RBs or odd-numbered RBs. For example, PT-RS ports 1 & 2 may be set to even-numbered RBs (0, 2, 4, 6, . . . ), and PT-RS ports 3 & 4 may be set to odd-numbered RBs (1, 3, 5, 7, . . . ).

Indexes of four PTRS ports may be 0 to 3. In other words, PTRS ports to which the existing method is applied may be PTRS ports 0 & 1, and PTRS ports to which the present embodiment is applied may be PTRS ports 2 & 3.

### <Proposal 3>

A method of differently configuring values of time density thresholds (e.g., ptrs-MCS1 to ptrs-MCS4) may be considered.

RS overhead in the time domain can be reduced by differently configuring values of the time density thresholds without changing the time density (L_{PT-RS}) in the proposal 1.

A value different from the existing configured/defined value may be utilized as the threshold value defined in Table 4 above. For example, the time density may be determined based on a different value from the value set through the parameter timeDensity. The different value may be configured by the base station to the UE.

For example, it may be assumed that ptrs-MCS₁ to ptrs-MCS₄ are set/determined to 14, 19, 24, and 29, respectively. Specifically, ptrs-MCS₁ to ptrs-MCS₃ may be set to 14, 19, and 24 by the parameter timeDensity, and ptrs-MCS₄ may be assumed to be 29. According to the present embodiment, new ptrs-MCS₁ to ptrs-MCS₄ may be set/determined to 14, 24, 27, and 29. In this case, the range of Imcs to which time density 4 is applied may be expanded from 14 or more and less than 19 to 14 or more and less than 24.

According to an embodiment, the values of new time density thresholds (new ptrs-MCS₁ to ptrs-MCS₄) may be set separately from the existing parameter timeDensity.

According to an embodiment, for the values of new time density thresholds (new ptrs-MCS₁ to ptrs-MCS₄), offset(s) applied to ptrs-MCS₁ to ptrs-MCS₃ based on the existing parameter timeDensity may be configured. For example, an offset may be configured for each of ptrs-MCS₁ to ptrs-MCS₃ (a total of three offsets may be configured). For example, one offset commonly applied to each of ptrs-MCS₁ to ptrs-MCS₃ may be set. In this instance, since ptrs-MCS₄ uses a value (e.g., 28 or 29) that is larger than the largest Imcs in the MCS table by 1, new ptrs-MCS₄ may also be defined as the same value, or an offset applied to the existing defined ptrs-MCS₄ may be additionally configured for new ptrs-MCS₄.

According to an embodiment, for the values of new time density thresholds (new ptrs-MCS₁ to ptrs-MCS₄), scaling value(s) applied to ptrs-MCS₁ to ptrs-MCS₄ based on the existing parameter timeDensity may be set.

In the above-described embodiments, new ptrs-MCS₁ to ptrs-MCS₄, the offset, and/or the scaling value may not be set separately, but may be pre-defined between the UE and the base station.

If the above-described mitigation conditions are satisfied (e.g., if the maximum number of PT-RS ports or the actual number of PT-RS ports is 3 or more), ptrs-MCS₁ to ptrs-MCS₄ in the table (Table 4) for determining the existing time density may be replaced with new ptrs-MCS₁ to ptrs-MCS₄, and the time density may be determined based on the thresholds.

The new ptrs-MCS₁ to ptrs-MCS₄ based on the present embodiment may be applied only to PTRS ports 3 & 4 (or PTRS ports 2 & 3) as in the proposal 2. Specifically, the time density for PTRS ports 1 & 2 (or PTRS ports 0 & 1) may be determined based on ptrs-MCS₁ to ptrs-MCS₄, and the time density for PTRS ports 3 & 4 (or PTRS ports 2 & 3) may be determined based on new ptrs-MCS₁ to ptrs-MCS₄.

TABLE 8
Table 6.2.3.1-1: Time density of PT-RS
as a function of scheduled MCS

| Scheduled MCS | Time density (L_{PT-RS}) |
|---|---|
| I_{MCS} < N1 | PT-RS is not present |
| N1 ≤ I_{MCS} < N2 | 4 |
| N2 ≤ I_{MCS} < N3 | 2 |
| N3 ≤ I_{MCS} < N4 | 1 |

In Table 8, N1 to N4 denote new ptrs-MCS₁ to ptrs-MCS₄.

### <Proposal 4>

A method of expanding a criterion that increases based on a threshold (frequency density threshold) of N_{RB} may be considered. The ‘expansion of the criterion that increases based on the threshold of N_{RB}’ means changing a value of K_{PT-RS} defined in the table (Table 5) for determining a frequency density to an increased value.

If a frequency density (K_{PT-RS}) determined based on a threshold of a scheduled bandwidth (N_{RB}) is determined as a value greater than the value defined in Table 5, the RS overhead in the frequency domain may be reduced. The N_{RB} means the number of resource blocks (RBs) related to the scheduled bandwidth. The N_{RB} may be determined based on a frequency domain resource assignment field of DCI.

As the number of ports increases twice, a region where PTRS is mapped in the frequency domain may be set to half. Specifically, K_{PT-RS} (2, 4) defined in Table 5 may be set to twice (4, 8) the value. In this case, the configured PTRS may have the same RS overhead as before.

This is described using an example where 4 PT-RS ports are configured and N_{RB0}≤N_{RB}<N_{RB1}. According to the existing method (Table 5), the frequency density may be determined as 2. According to the present embodiment, the frequency density may be determined as 4 (which is twice the existing defined value).

In addition, in the same manner as the proposal 1, the frequency density may be determined as a different value per the maximum number of PTRS ports.

For example, if the maximum number of PTRS ports is 3, the frequency density may be determined as a value (e.g., 4, 8) which is twice the value defined in Table 5 so that the density (RS overhead) is ½ compared to when the maximum number of PTRS ports is 1 or 2.

For example, if the maximum number of PTRS ports is 4, the frequency density may be determined as a value (e.g., 6, 12) which is three times the value defined in Table 5 so that the density (RS overhead) is ⅓ compared to when the maximum number of PTRS ports is 1 or 2. A reduction ratio (X=½, Y=⅓) of the density per the maximum number of PTRS ports is an example, and the corresponding value may be configured to the UE by the base station. For example, if a value of X for the maximum number of PTRS ports of 3 is set to ¼, the frequency density may be determined as a value (e.g., 8, 16) that is four times the value defined in Table 5. For example, if a value of Y for the maximum number of PTRS ports of 4 is set to ⅕, the frequency density may be determined as a value (e.g., 10, 20) that is five times the value defined in Table 5. The base station may configure, to the UE, a multiple value (e.g., 2, 3) corresponding to the value of X/Y, not the value of X/Y (e.g., ½ and ⅓).

Table 9 below is a table for applying the values (K_{PT-RS}) defined in Table 5 by doubling them.

TABLE 9
Table 6.2.3.1-2: Frequency density of PT-RS
as a function of scheduled bandwidth

| Scheduled bandwidth | Frequency density (K_{PT-RS}) |
|---|---|
| N_{RB} < N_{RB0} | PT-RS is not present |
| N_{RB0} ≤ N_{RB} < N_{RB1} | 4 |
| N_{RB1} ≤ N_{RB} | 8 |

### <Proposal 5>

A method of limiting the PTRS ports, to which the embodiment defined in the proposal 4 is applied, to a specific port (PTRS port 3/4 or the third/fourth PTRS port) may be considered. Specifically, the frequency density for port 1 and/or port 2 (the first PTRS port and/or the second PTRS port) may be determined based on the existing method (Table 5). In other words, the same frequency density as before may be utilized up to the first two PTRS ports.

When port 3 and/or port 4 are configured, the frequency density for the third/fourth PTRS port may be determined based on the proposal 4 described above so as to reduce RS overhead. That is, PTRS ports 1 & 2 may be configured based on the frequency density determined based on the existing method, and PTRS ports 3 & 4 may be configured based on the frequency density determined based on an embodiment (e.g., proposal 4) for reducing the RS overhead.

For example, the frequency density for PTRS ports 3 & 4 may be determined as a value (e.g., 4, 8) applying a multiple of the value defined in Table 5. For example, the frequency density for PTRS ports 3 & 4 may use values other than the value applying the multiple of the value defined in Table 5. Specifically, the frequency density for PTRS ports 3 & 4 may be determined as a value separately configured by the base station to the UE.

PT-RS ports 1 and 2 (or 0 and 1) and PT-RS ports 3 and 4 (or 2 and 3) may be configured to be distinguished based on even-numbered RBs or odd-numbered RBs. For example, PT-RS ports 1 & 2 may be set to even-numbered RBs (0, 2, 4, 6, . . . ), and PT-RS ports 3 & 4 may be set to odd-numbered RBs (1, 3, 5, 7, . . . ).

Indexes of four PTRS ports may be 0 to 3. In other words, PTRS ports to which the existing method is applied may be PTRS ports 0 & 1, and PTRS ports to which the present embodiment is applied may be PTRS ports 2 & 3.

### <Proposal 6>

A method of differently configuring values of frequency density thresholds (N_{RB0} and N_{RB1}) may be considered.

RS overhead in the frequency domain can be reduced by differently configuring values of the frequency density thresholds without changing the frequency density (K_{PT-RS}) in the proposal 4.

A value different from the existing configured/defined value may be utilized as the threshold value defined in Table 5 above. For example, the frequency density may be determined based on a different value from the value set through the parameter frequencyDensity. The different value may be configured by the base station to the UE.

For example, it may be assumed that N_{RB0} and N_{RB1} are set to 40 and 80, respectively. According to the present embodiment, new N_{RB0} and N_{RB1} may be set/determined to 20 and 40. In this case, the range of N_{RB} to which frequency density 4 is applied may be expanded from values between 80 and 276 (maximum value) to values between 40 and 276.

According to an embodiment, the values of new frequency density thresholds (new N_{RB0} to N_{RB1}) may be set separately from the existing parameter frequencyDensity.

According to an embodiment, for the values of new frequency density thresholds (new N_{RB0} to N_{RB1}), offset(s) applied to N_{RB0} to N_{RB1} based on the existing parameter frequencyDensity may be configured. For example, an offset may be configured for each of new N_{RB0} to N_{RB1} (a total of two offsets may be configured). For example, one offset commonly applied to each of new N_{RB0} to N_{RB1} may be set.

According to an embodiment, for the values of new frequency density thresholds (new N_{RB0} to N_{RB1}), scaling value(s) applied to new N_{RB0} to N_{RB1} based on the existing parameter frequencyDensity may be set.

In the above-described embodiments, new N_{RB0} to N_{RB1}, the offset, and/or the scaling value may not be set separately, but may be pre-defined between the UE and the base station.

If the above-described mitigation conditions are satisfied (e.g., if the maximum number of PT-RS ports or the actual number of PT-RS ports is 3 or more), N_{RB0} to N_{RB1} in the table (Table 5) for determining the existing frequency density may be replaced with new N_{RB0} to N_{RB1}, and the frequency density may be determined based on the thresholds.

The new N_{RB0} to N_{RB1} based on the present embodiment may be applied only to PTRS ports 3 & 4 (or PTRS ports 2 & 3) as in the proposal 5. Specifically, the frequency density for PTRS ports 1 & 2 (or PTRS ports 0 & 1) may be determined based on N_{RB0} to N_{RB1}, and the time density for PTRS ports 3 & 4 (or PTRS ports 2 & 3) may be determined based on new N_{RB0} to N_{RB1}.

TABLE 10
Table 6.2.3.1-2: Frequency density of PT-RS
as a function of scheduled bandwidth

| Scheduled bandwidth | Frequency density (K_{PT-RS}) |
|---|---|
| N_{RB} < N1 | PT-RS is not present |
| N1 ≤ N_{RB} < N2 | 2 |
| N2 ≤ N_{RB} | 4 |

In Table 10, N1 to N2 denote new N_{RB0} to N_{RB1}.

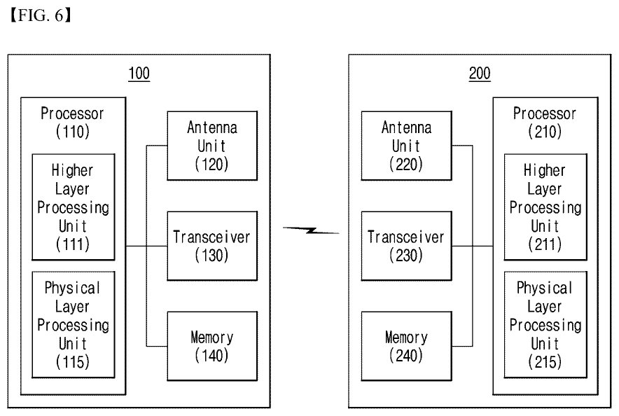

From an implementation perspective, the operations (e.g., operations based on at least one of the proposals 1 to 6) of the base station/UE according to the above-described embodiments may be processed by a device described below with reference to FIG. 6 (e.g., 100 and 200 of FIG. 6).

The operations (e.g., operations based on at least one of the proposals 1 to 6) of the base station/UE according to the above-described embodiments may be stored in a memory (e.g., memories 140 and 240 of FIG. 6) in the form of a command/program (e.g., instructions, executable codes) for running at least one processor (e.g., processors 110 and 210 of FIG. 6).

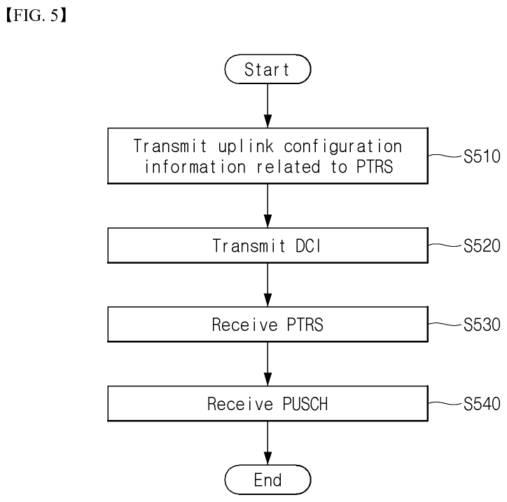

Below, the above-described embodiments are described in detail from a perspective of operations of the UE and the base station with reference to FIGS. 4 and 5. Methods described below are merely distinguished for convenience of explanation. Thus, as long as the methods are not mutually exclusive, it is obvious that partial configuration of any method can be substituted or combined with partial configuration of another method.

FIG. 4 is a flowchart illustrating a method performed by a user equipment according to an embodiment of the present disclosure.

Referring to FIG. 4, a method performed by a user equipment (UE) in a wireless communication system according to an embodiment of the present disclosure may include a step S410 of receiving uplink configuration information related to PTRS, a step S420 of receiving DCI, a step S430 of transmitting the PTRS, and a step S440 of transmitting PUSCH.

In the step S410, the UE receives, from a base station, uplink configuration information related to a phase tracking reference signal (PTRS). The uplink configuration information related to the PTRS may be based on PTRS-UplinkConfig of Table 6.

The uplink configuration information related to the PTRS may include information for at least one time density threshold and information for at least one frequency density threshold described below.

The uplink configuration information related to the PTRS may further include information based on the proposals 1 to 6. For example, the uplink configuration information related to the PTRS may further include at least one of the following [1] to [4].
[1] Information related to time density value(s) (e.g., offset(s), scaling value and/or time density values for PTRS ports 2 and 3)
[2] Information related to the time density threshold related to a maximum number of the PTRS ports of 3 or 4 (e.g., new ptrs-MCS₁ to ptrs-MCS₄)
[3] Information related to frequency density values (e.g., offset(s), scaling value and/or frequency density values for PTRS ports 2 and 3)
[4] Information related to the frequency density thresholds related to a maximum number of the PTRS ports of 3 or 4 (e.g., new N_{RB0} to N_{RB1})

The [1] to [4] above may be information pre-defined between the UE and the base station, not information configured via the uplink configuration information related to the PTRS.

In the step S420, the UE receives, from the base station, downlink control information (DCI) for scheduling a physical uplink shared channel (PUSCH). The DCI may include i) a modulation and coding scheme (MCS) field and ii) a frequency domain resource assignment field.

In the step S430, the UE transmits, to the base station, the PTRS based on a time density and a frequency density.

For example, physical resources to which the PTRS is mapped may be determined based on the time density and the frequency density. Time indexes (e.g., symbol indexes) related to the physical resources may be defined/determined based on the time density. Subcarriers related to the physical resources may be determined based on the frequency density.

The time density may be determined as one of the time density values based on a comparison between an MCS index (e.g., I_{MCS} in Table 4) indicated based on the MCS field and the at least one time density threshold (e.g., ptrs-MCS₁ to ptrs-MCS₄ in Table 4).

The frequency density may be determined as one of the frequency density values based on a comparison between the number of resource blocks (RBs) (e.g., N_{RB} in Table 5) based on the frequency domain resource assignment field and the at least one frequency density threshold (e.g., N_{RB0} and N_{RB1} in Table 5).

At least one of the at least one time density threshold, the at least one frequency density threshold, the time density values and/or the frequency density values may be based on a maximum number of PTRS ports related to the PTRS.

In other words, at least one of the at least one time density threshold, the at least one frequency density threshold, the time density values and/or the frequency density values may be configured/determined/defined based on the maximum number of PTRS ports related to the PTRS. The present embodiment may be based on at least one of the proposals 1 to 6. An embodiment for each proposal is described in detail below.

Embodiments based on at least one of the proposals 1 to 3 is first described.

According to an embodiment, based on the maximum number of the PTRS ports being 1 or 2, the time density may be determined as one of first time density values. The first time density values may be based on values (e.g., 1, 2, and 4 in Table 4) defined in a table based on an existing method. The present embodiment may be based on the proposal 1 and/or the proposal 2.

According to an embodiment, based on the maximum number of the PTRS ports being 3 or 4, the time density may be determined as one of the first time density values and/or second time density values. The present embodiment may be based on the proposal 1 and/or the proposal 2. The second time density values may be values configured/defined to prevent RS overhead from excessively increasing due to an increase in the number of the PTRS ports. For example, the second time density values may be based on values (e.g., 2, 4, and 8) defined in Table 7.

According to an embodiment, the time density for PTRS port 0 and PTRS port 1 among four PTRS ports may be determined as one of the first time density values. The time density for PTRS port 2 and PTRS port 3 among the four PTRS ports may be determined as one of the second time density values. The present embodiment may be based on the proposal 2.

For example, the respective PTRS ports (0-1 and 2-3) may be distinguished based on even-numbered RBs/odd-numbered RBs. Specifically, the PTRS port 0 and the PTRS port 1 may be related to the even-numbered RBs or the odd-numbered RBs. The PTRS port 2 and the PTRS port 3 may be related to the odd-numbered RBs or the even-numbered RBs.

According to an embodiment, the at least one time density threshold may include four time density thresholds (e.g., ptrs-MCS₁ to ptrs-MCS₄ in Table 4). The present embodiment may be based on the proposal 1 and/or the proposal 2.

For each of three MCS index ranges based on the four time density thresholds, three first time density values and three second time density values may be defined. For example, the three MCS index ranges may be based on Table 4 (e.g., in Table 4, ptrs-MCS₁≤I_{MCS}<ptrs-MCS₂, [2] ptrs-MCS₂≤I_{MCS}<ptrs-MCS₃, [3] ptrs-MCS₃≤I_{MCS}≤ptrs-MCS₄).

For the same MCS index range, the second time density value may be greater than the first time density value. For example, for ptrs-MCS₁≤I_{MCS}<ptrs-MCS₂, the second time density value may be 8, and the first time density value may be 4.

According to an embodiment, the at least one time density threshold may include i) first time density thresholds (e.g., ptrs-MCS₁ to ptrs-MCS₄) related to the maximum number of the PTRS ports of 1 or 2 and/or ii) second time density thresholds (e.g., new ptrs-MCS₁ to ptrs-MCS₄) related to the maximum number of the PTRS ports of 3 or 4. The present embodiment may be based on the proposal 3.

Embodiments based on at least one of the proposals 4 to 6 is described below.

According to an embodiment, based on the maximum number of the PTRS ports being 1 or 2, the frequency density may be determined as one of first frequency density values. The first frequency density values may be based on values (e.g., 2 and 4 in Table 5) defined in a table based on an existing method. The present embodiment may be based on the proposal 4 and/or the proposal 5.

According to an embodiment, based on the maximum number of the PTRS ports being 3 or 4, the frequency density may be determined as one of the first frequency density values and/or second frequency density values. The present embodiment may be based on the proposal 4 and/or the proposal 5. The second frequency density values may be values configured/defined to prevent RS overhead from excessively increasing due to an increase in the number of the PTRS ports. For example, the second frequency density values may be based on values (e.g., 4 and 8) defined in Table 9.

According to an embodiment, the frequency density for PTRS port 0 and PTRS port 1 among four PTRS ports may be determined as one of the first frequency density values. The frequency density for PTRS port 2 and PTRS port 3 among the four PTRS ports may be determined as one of the second frequency density values. The present embodiment may be based on the proposal 5.

For example, the respective PTRS ports (0-1 and 2-3) may be distinguished based on even-numbered RBs/odd-numbered RBs. Specifically, the PTRS port 0 and the PTRS port 1 may be related to the even-numbered RBs or the odd-numbered RBs. The PTRS port 2 and the PTRS port 3 may be related to the odd-numbered RBs or the even-numbered RBs.

According to an embodiment, the at least one frequency density threshold may include two frequency density thresholds (e.g., N_{RB0} and N_{RB1} in Table 5). The present embodiment may be based on the proposal 4 and/or the proposal 5.

For each of two RB number ranges based on the two frequency density thresholds, two first frequency density values and two second frequency density values may be defined. For example, the two RB number ranges may be based on Table 5 (e.g., in Table 5, [1] N_{RB0}≤N_{RB}≤N_{RB1}, [2] N_{RB1}≤N_{RB}).

For the same RB number range, the second frequency density value may be greater than the first frequency density value. For example, for N_{RB0}≤N_{RB}≤N_{RB1}, the second frequency density value may be 4, and the first frequency density value may be 2.

According to an embodiment, the at least one frequency density threshold may include i) first frequency density thresholds (e.g., N_{RB0} to N_{RB1}) related to the maximum number of the PTRS ports of 1 or 2 and/or ii) second frequency density thresholds (e.g., new N_{RB0} to N_{RB1}) related to the maximum number of the PTRS ports of 3 or 4. The present embodiment may be based on the proposal 6.

For convenience of description, embodiments related to the time density (proposals 1 to 3) and embodiments related to the frequency density (proposals 4 to 6) are described separately, but embodiments related to the time density can be applied to the UE/base station operation in combination with embodiments related to the frequency density. For example, at least one of the proposals 1 to 3 may be combined with at least one of the proposals 4 to 6.

In the step S440, the UE transmits the PUSCH to the base station.

For example, a transmission scheme related to the PUSCH may be configured as codebook or non-codebook.

For example, the number of layers related to the PUSCH may be greater than 4. For example, a rank related to the PUSCH may be greater than or equal to 5.

The operations based on the above-described steps S410 to S440 may be implemented by a device of FIG. 6. For example, a UE 200 may control one or more transceivers 230 and/or one or more memories 240 to perform the operations based on the steps S410 to S440.

Some steps may be omitted or added in the method. For example, the operation based on the step S440 may be omitted in the method.

Below, the above-described embodiments are described in detail from a perspective of base station operation.

Steps S510 to S540 described below correspond to the steps S410 to S440 described with reference to FIG. 4. Considering the above correspondence, redundant description is omitted. That is, the detailed description of the base station operation described below can be replaced with the description/embodiment of FIG. 4 corresponding to the base station operation. For example, the description/embodiment of the steps S410 to S440 of FIG. 4 may be additionally applied to the base station operation of the steps S510 to S540 described below.

FIG. 5 is a flowchart illustrating a method performed by a base station according to another embodiment of the present disclosure.

Referring to FIG. 5, a method performed by a base station in a wireless communication system according to another embodiment of the present disclosure may include a step S510 of transmitting uplink configuration information related to PTRS, a step S520 of transmitting DCI, a step S530 of receiving the PTRS, and a step S540 of receiving PUSCH.

In the step S510, the base station transmits, to a UE, uplink configuration information related to a phase tracking reference signal (PTRS).

In the step S520, the base station transmits, to the UE, downlink control information (DCI) for scheduling a physical uplink shared channel (PUSCH).

In the step S530, the base station receives, from the UE, the PTRS based on a time density and a frequency density.

In S540, the base station receives the PUSCH from the UE.

The operations based on S510 to S540 described above may be implemented by the device of FIG. 6. For example, the BS 100 may control one or more transceivers 130 and/or one or more memories 140 to perform the operations based on S510 to S540.

Some steps may be omitted or added in the method. As one example, in the method, the operation based on S540 may be omitted.

A device to which an embodiment of the present disclosure is applicable (a device implementing the method/operation according to an embodiment of the present disclosure) is described below with reference to FIG. 6.

FIG. 6 illustrates configuration of a first device and a second device according to an embodiment of the present disclosure.

A first device 100 may include a processor 110, an antenna unit 120, a transceiver 130, and a memory 140.

The processor 110 may perform baseband-related signal processing and include a higher layer processing unit 111 and a physical layer processing unit 115. The higher layer processing unit 111 may process operations of the MAC layer, the RRC layer, or higher layers. The physical layer processing unit 115 may process the operation of the PHY layer. For example, if the first device 100 is a base station (BS) device in BS-UE communication, the physical layer processing unit 115 may perform uplink reception signal processing, downlink transmission signal processing, and the like. For example, if the first device 100 is a first UE device in inter-UE communication, the physical layer processing unit 115 may performs downlink reception signal processing, uplink transmission signal processing, sidelink transmission signal processing, and the like. The processor 110 may control the overall operation of the first device 100 in addition to performing the baseband-related signal processing.

The antenna unit 120 may include one or more physical antennas and support MIMO transmission/reception if the antenna unit 120 includes a plurality of antennas. The transceiver 130 may include a radio frequency (RF) transmitter and an RF receiver. The memory 140 may store information processed by the processor 110 and software, operating systems, and applications related to the operation of the first device 100. The memory 140 may also include components such as a buffer.

The processor 110 of the first device 100 may be configured to implement the operation of the BS in the BS-UE communication (or the operation of the first UE device in the inter-UE communication) in embodiments described in the present disclosure.

The second device 200 may include a processor 210, an antenna unit 220, a transceiver 230, and a memory 240.

The processor 210 may perform baseband-related signal processing and include a higher layer processing unit 211 and a physical layer processing unit 215. The higher layer processing unit 211 may process the operation of the MAC layer, the RRC layer, or higher layers. The physical layer processing unit 215 may process the operation of the PHY layer. For example, if the second device 200 is a UE device in BS-UE communication, the physical layer processing unit 215 may perform downlink reception signal processing, uplink transmission signal processing, and the like. For example, if the second device 200 is a second UE device in inter-UE communication, the physical layer processing unit 215 may perform downlink reception signal processing, uplink transmission signal processing, sidelink reception signal processing, and the like. The processor 210 may control the overall operation of the second device 210 in addition to performing the baseband-related signal processing.

The antenna unit 220 may include one or more physical antennas and support MIMO transmission/reception if the antenna unit 220 includes a plurality of antennas. The transceiver 230 may include an RF transmitter and an RF receiver. The memory 240 may store information processed by the processor 210 and software, operating systems, and applications related to the operation of the second device 200. The memory 240 may also include components such as a buffer.

The processor 210 of the second device 200 may be configured to implement the operation of the UE in the BS-UE communication (or the operation of the second UE device in the inter-UE communication) in embodiments described in the present disclosure.

The descriptions for the BS and the UE in the BS-UE communication (or the first UE device and the second UE device in the inter-UE communication) in the examples of the present disclosure can be equally applied to the operations of the first device 100 and the second device 200, and redundant descriptions are omitted.

The wireless communication technology implemented in the devices 100 and 200 according to the present disclosure may further include narrowband Internet of Things (NB-IoT) for low-power communication in addition to LTE, NR, and 6G. For example, the NB-IoT technology may be an example of a low power wide area network (LPWAN) technology and may be implemented in standards such as LTE Cat NB1 and/or LTE Cat NB2. The NB-IoT technology is not limited to the above-described names.

Additionally or alternatively, the wireless communication technology implemented in the devices 100 and 200 according to the present disclosure may perform communication based on LTE-M technology. For example, the LTE-M technology may be an example of the LPWAN technology, and may be called by various names such as enhanced machine type communication (eMTC). For example, the LTE-M technology may be implemented with at least one of various standards such as 1) LTE CAT 0, 2) LTE Cat M1, 3) LTE Cat M2, 4) LTE non-BL (non-Bandwidth Limited), 5) LTE-MTC, 6) LTE machine type communication, and/or 7) LTE M. The LTE-M technology is not limited to the above-mentioned names.

Additionally or alternatively, the wireless communication technology implemented in the devices 100 and 200 according to the present disclosure may include at least one of ZigBee, Bluetooth, and low power wide area network (LPWAN) in consideration of low power communication, and is not limited to the above-mentioned names. For example, the ZigBee technology may create personal area networks (PAN) related to small/low-power digital communication based on various standards such as IEEE 802.15.4, and may be called by various names.

1. A method performed by a user equipment comprising:
receiving uplink configuration information related to a phase tracking reference signal (PTRS);
receiving downlink control information (DCI) for scheduling a physical uplink shared channel (PUSCH), wherein the DCI includes i) a modulation and coding scheme (MCS) field and ii) a frequency domain resource assignment field;
transmitting the PTRS based on a time density and a frequency density; and
transmitting the PUSCH,
wherein the time density is determined as one of time density values based on a comparison between an MCS index indicated based on the MCS field and at least one time density threshold,
wherein the frequency density is determined as one of frequency density values based on a comparison between a number of resource blocks (RBs) based on the frequency domain resource assignment field and at least one frequency density threshold, and
wherein at least one of the at least one time density threshold, the at least one frequency density threshold, the time density values and/or the frequency density values is based on a maximum number of PTRS ports related to the PTRS.

2. The method of claim 1, wherein based on the maximum number of the PTRS ports being 1 or 2, the time density is determined as one of first time density values.

3. The method of claim 2, wherein based on the maximum number of the PTRS ports being 3 or 4, the time density is determined as one of the first time density values and/or second time density values.

4. The method of claim 3, wherein the time density for PTRS port 0 and PTRS port 1 among four PTRS ports is determined as one of the first time density values, and
wherein the time density for PTRS port 2 and PTRS port 3 among the four PTRS ports is determined as one of the second time density values.

5. The method of claim 4, wherein the PTRS port 0 and the PTRS port 1 are related to even-numbered RBs or odd-numbered RBs, and
wherein the PTRS port 2 and the PTRS port 3 are related to the odd-numbered RBs or the even-numbered RBs.

6. The method of claim 3, wherein the at least one time density threshold includes four time density thresholds,
wherein for each of three MCS index ranges based on the four time density thresholds, three first time density values and three second time density values are defined, and
wherein for the same MCS index range, the second time density value is greater than the first time density value.

7. The method of claim 1, wherein the at least one time density threshold includes i) first time density thresholds related to the maximum number of the PTRS ports of 1 or 2 and/or ii) second time density thresholds related to the maximum number of the PTRS ports of 3 or 4.

8. The method of claim 1, wherein based on the maximum number of the PTRS ports being 1 or 2, the frequency density is determined as one of first frequency density values.

9. The method of claim 8, wherein based on the maximum number of the PTRS ports being 3 or 4, the frequency density is determined as one of the first frequency density values and/or second frequency density values.

10. The method of claim 9, wherein the frequency density for PTRS port 0 and PTRS port 1 among four PTRS ports is determined as one of the first frequency density values, and
wherein the frequency density for PTRS port 2 and PTRS port 3 among the four PTRS ports is determined as one of the second frequency density values.

11. The method of claim 10, wherein the PTRS port 0 and the PTRS port 1 are related to even-numbered RBs or odd-numbered RBs, and
wherein the PTRS port 2 and the PTRS port 3 are related to the odd-numbered RBs or the even-numbered RBs.

12. The method of claim 9, wherein the at least one frequency density threshold includes two frequency density thresholds,
wherein for each of two RB number ranges based on the two frequency density thresholds, two first frequency density values and two second frequency density values are defined, and
wherein for the same RB number range, the second frequency density value is greater than the first frequency density value.

13. The method of claim 1, wherein the at least one frequency density threshold includes i) first frequency density thresholds related to the maximum number of the PTRS ports of 1 or 2 and/or ii) second frequency density thresholds related to the maximum number of the PTRS ports of 3 or 4.

14. The method of claim 1, wherein a number of layers related to the PUSCH is greater than 4.

15. A user equipment comprising:
one or more transceivers;
one or more processors; and
one or more memories connected to the one or more processors and storing instructions,
wherein the instructions configure the one or more processors to perform operations based on being executed by the one or more processors,
wherein the operations comprise:
receiving uplink configuration information related to a phase tracking reference signal (PTRS);
receiving downlink control information (DCI) for scheduling a physical uplink shared channel (PUSCH), wherein the DCI includes i) a modulation and coding scheme (MCS) field and ii) a frequency domain resource assignment field;
transmitting the PTRS based on a time density and a frequency density; and
transmitting the PUSCH,
wherein the time density is determined as one of time density values based on a comparison between an MCS index indicated based on the MCS field and at least one time density threshold,
wherein the frequency density is determined as one of frequency density values based on a comparison between a number of resource blocks (RBs) based on the frequency domain resource assignment field and at least one frequency density threshold, and
wherein at least one of the at least one time density threshold, the at least one frequency density threshold, the time density values and/or the frequency density values is based on a maximum number of PTRS ports related to the PTRS.

16-17. (canceled)

18. A base station comprising:
one or more transceivers;
one or more processors; and
one or more memories connected to the one or more processors and storing instructions,
wherein the instructions configure the one or more processors to perform operations based on being executed by the one or more processors,
wherein the operations comprise:
transmitting uplink configuration information related to a phase tracking reference signal (PTRS);
transmitting downlink control information (DCI) for scheduling a physical uplink shared channel (PUSCH), wherein the DCI includes i) a modulation and coding scheme (MCS) field and ii) a frequency domain resource assignment field;
receiving the PTRS based on a time density and a frequency density; and
receiving the PUSCH,
wherein the time density is determined as one of time density values based on a comparison between an MCS index indicated based on the MCS field and at least one time density threshold,
wherein the frequency density is determined as one of frequency density values based on a comparison between a number of resource blocks (RBs) based on the frequency domain resource assignment field and at least one frequency density threshold, and
wherein at least one of the at least one time density threshold, the at least one frequency density threshold, the time density values and/or the frequency density values is based on a maximum number of PTRS ports related to the PTRS.

19. (canceled)
